(19) United States
(12) Patent Application Publication
(10) Pub. No.: US 2006/0047348 A1
(43) Pub. Date: Mar. 2, 2006

(54) Method and system for dynamically controlling equipment actions

(76) Inventors: Chun-Yen Teng, Tainan Science Based Industrial Park (TW); Chi-Yao Lo, Tainan Science Based Industrial Park (TW)

Correspondence Address: PRO-TECHTOR INTERNATIONAL, 20775 Norada Court, Saratoga, CA, 95070-3018, US

(21) Appl. No.: 10/930,072

(22) Filed: Aug. 30, 2004

(51) Int. Cl. G05B 11/01

(52) U.S. Cl. 700/19; 700/20

(57) ABSTRACT

A method and a system for dynamically controlling equipment actions. The system for dynamically controlling the equipment actions includes a plurality of reference equipment-controlling means, a scenario editor, a condition/data set object and a editing-result file, wherein the editing-result file is coded with Extensible Markup Language (XML) or other storage media, and the reference equipment-controlling means are made as DLLs (Dynamic Link Libraries). The method for dynamically controlling the equipment actions mainly uses a new editing-result file to replace the original editing-result file, and then to enable the scenario editor to load in the new editing-result file for execution, so as to change the equipment actions.

### FIELD OF THE INVENTION

The present invention relates to a system and a method for dynamically controlling equipment actions, and more particularly, to the system and the method which can edit equipment actions and dynamically change the equipment actions without stopping the operation of the equipments.

### BACKGROUND OF THE INVENTION

Since an IC fabrication involves complicated manufacturing steps, expensive processing equipments, numerous product varieties and short product life cycles, IC makers have to apply computer integrated manufacturing (CIM) procedures for properly utilizing all kinds of manufacturing resources by controlling material and information flows. The so-called CIM is centralized in a database by means of computers, and then through a computer networking, passes the information stored in the database to users speedily, or integrates various automatic facilities into an integrated automatic production system. In January 1997, from an article in Semiconductor International Journal, it is reported that “the installation of a CIM system is mission-critical in the start-up of new fabs and in the on-going development of current ones”, wherein MES (Manufacturing Execution system) is the core of CIM.

The conventional MES generally implements an scenario-managing program exclusively with respect to each of the equipments by writing independent programs individually, and also codes the equipment actions directly into programs, i.e. each equipment has its own scenario-managing program for managing its equipment actions. In case the sequence of equipment actions of certain equipment or certain judgment rules thereof are changed, the scenario-managing program has to be re-edited and the related execution files has to be re-compiled. Meanwhile, while the scenario-managing program is renewed, the operation of the related equipments has to be stopped so as to successfully load in the scenario-managing program.

A conventional scenario-managing program generally includes developer-defined equipment control procedures, condition parameters and specific execution operations required under various conditions, wherein those specific operations are a set of functions developed by the developers in accordance with the program requirements. The conventional scenario-managing program has the shortcomings of that: the program function library developed by the developers does not use the object-oriented skill, thus resulting in difficulty in management and maintenance; while being deployed, related software has to be linked with the function library developed by the developers and to be re-compiled, so that the software is difficult to be renewed; since the software is developed especially for semiconductor industries, it is not applicable to other industries. Further, different scenario-managing programs have to be developed specifically for individual equipments even though the equipments are of the same type, so that the scenario-managing programs cannot be shared among the equipments.

To sum up, the conventional technology using scenario-managing programs needs to take a lot of manpower and material resource to modify and maintain the related programs; cannot dynamically change the equipment actions, and has to stop the operations of the equipments before renewing the scenario-managing programs, thus resulting production interruption.

Hence, there is an urgent need to develop a method and a system for dynamically controlling equipment actions, so that the equipment actions can be changed without stopping the operations of the equipments beforehand, and the scenario-managing programs can be conveniently developed and maintained.

### SUMMARY OF THE INVENTION

An aspect of the present invention is to provide a method and system equipments for dynamically controlling equipment actions, thereby dynamically changing the equipment actions without needing to stop the equipment operations, thus achieving the goal of plug-in and play.

Another aspect of the present invention is to provide a method and system equipments for dynamically controlling equipment actions, thereby conveniently developing and maintaining the related scenario-managing programs, so that developers merely need to focus on the development of equipment action objects and on the scenario editing.

Another aspect of the present invention is to provide a method and system equipments for dynamically controlling equipment actions, thereby developing scenario-editing results suitable for use in various types of equipment.

According to the aforementioned aspects, a system and a method for dynamically controlling equipment actions are provided for editing and controlling the equipment actions.

In the method for dynamically controlling equipment actions, a plurality of reference equipment-controlling means, a scenario editor and a data-condition setting object are first provided. The reference equipment-controlling means are used for controlling a plurality of reference actions of a plurality of reference equipments, and each of the reference equipment-controlling means includes a reference equipment driver. A scenario editor is used for defining at least one equipment action of an equipment, and assigns an equipment-controlling means suitable for the equipment from the reference equipment-controlling means. A data-condition setting object is used as a communication interface between the scenario editor and the equipment-controlling means, and the data-condition setting object controls the input/output (I/O) of the equipment-controlling means. Then, an editing-result file is provided for storing results edited in the scenario editor. After the scenario editor loads in the editing-result file, the scenario editor is executed to change the equipment actions of the equipment.

According to the present invention, the steps for executing the scenario editor are described as follows. At first, the equipment driver of the equipment-controlling means is executed. Then, a status number and status data are transmitted, and the status number and the status data required by the equipment action are delivered to the scenario editor for execution, when the equipment driver triggers the equipment action. After the scenario editor receives the scenario number and the scenario data, the scenario objects of the scenario editor are searched and compared to determine a proper scenario object. Then, if the step objects of the proper scenario object match with the scenario number and the scenario data, then the step objects are executed.

Further, in the method for dynamically controlling equipment actions according to the present invention, a new editing-result file is first generated, and the new editing-result file is used to replace the original editing-result file. The scenario editor is continuously executed after loading in the new editing-result file, thereby dynamically changing the equipment actions.

According to the present invention, the system for dynamically controlling equipment actions includes a plurality of reference equipment-controlling means, a scenario editor, a data-condition setting object and an editing-result file. The reference equipment-controlling means are used for controlling a plurality of reference actions of a plurality of reference equipments, and each of the reference equipment-controlling means includes an equipment driver. The scenario editor is used for defining or changing at least one equipment action of an equipment, wherein the scenario editor assigns an equipment-controlling means suitable for the equipment from the reference equipment-controlling means. The data-condition setting object is used as a communication interface between the scenario editor and the equipment-controlling means, wherein the data-condition setting object controls the input/output (I/O) of the equipment-controlling means. The editing-result file is used for storing results edited in the scenario editor, and the scenario editor is executed after loading in the editing-result file.

Hence, with the application of the present invention, the equipment actions can be dynamically changed without needing to stop the equipment operations beforehand, thus achieving the goal of plug-in and play; the related scenario-managing programs can be conveniently developed and maintained, and developers merely need to focus on the development of equipment action objects and on the scenario editing; and scenario-editing results developed in the editor scenario is suitable for use in various types of equipment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing a system of the present invention for dynamically controlling equipment actions;

FIG. 2 is a flow chart showing the method of the present invention for dynamically controlling equipment actions;

FIG. 3 is a flow chart showing the steps of the present invention for executing a scenario editor; and

FIG. 4 is a flow chart showing the method of the present invention for dynamically changing equipment actions.

### DETAILED DESCRIPTION OF THE PREFERRED EMBODIMENT

The present invention is featured in using a scenario editor to edit equipment actions and in executing the scenario editor to control equipment actions.

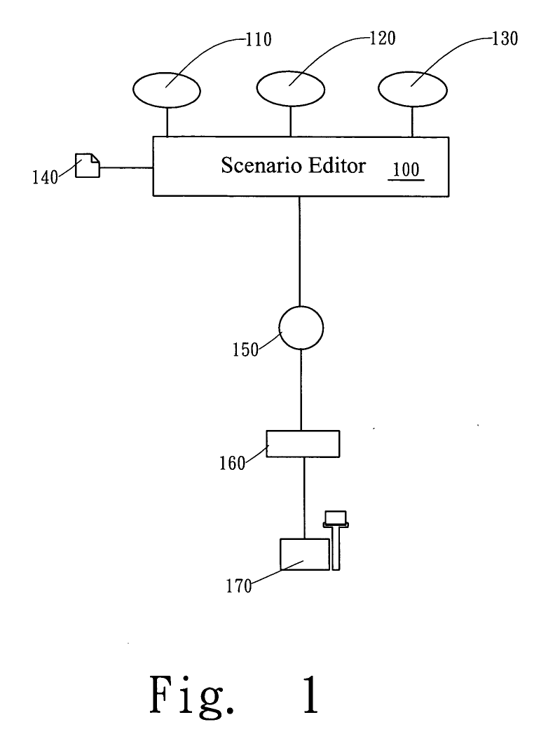

Referring to FIG. 1, FIG. 1 is a schematic diagram showing a system of the present invention for dynamically controlling equipment actions. According to the present invention, the system for dynamically controlling equipment actions is composed of a plurality of reference equipment-controlling means (not shown), a scenario editor and a data-condition setting object 150 and an editing-result file 140. The reference equipment-controlling means are used for controlling a plurality of reference actions of a plurality of reference equipments, wherein each of the reference equipment-controlling means includes an equipment driver (not shown). At first, a scenario editor 100 is used to define or change at least one equipment action of an equipment 170, and the scenario editor 100 assigns an equipment-controlling means 160 suitable for the equipment 170 from the reference equipment-controlling means, i.e. uses the equipment-controlling means 160 to control the equipment 170. The data-condition setting object 150 acts as the communication interface between the scenario editor 100 and the equipment-controlling means 160, and as the input/output (I/O) of the equipment-controlling means 160. The editing-result file 140 is used for storing the results of the equipment actions edited in the scenario editor with respect to the equipment 170, and the scenario editor 150 is executed after loading in the editing-result file 140.

For example, the following steps are input into the scenario editor 100 for describing the scenario of loading a wafer pod into an equipment: (1) moving in a wafer pod; (2) clamping the wafer pod; and (3) docking in the wafer pod. Then, the aforementioned steps are stored into the editing-result file 140. The editing-result file 140 can use XML (Extensible Markup Language) or a user-defined format, or can be a storage media of database. The reference equipment-controlling means are DLL (Dynamic Link Library) files, and have a plurality of action objects used for driving the equipment actions of the equipment 170. Further, the scenario editor 100 has a plurality of scenario objects, and each of the scenario objects has a plurality of step objects used for describing the equipment actions of a scenario. Thus, the reference equipment-controlling means and the scenario editor 100 all are designed with the concept of object-oriented skill. One of the features of the present invention is that the scenario editor 100 merely needs to focus on the task of editing the equipment actions regarding the equipment 170, and the task of driving the equipment 170 can be handled by the equipment-controlling means 160, wherein the equipment-controlling means 160 (selected from the reference equipment-controlling means) includes an equipment drive and an equipment communication protocol. Hence, the developers only need to focus on the development of the objects related to the equipment actions, and use the scenario editor 100 to edit the relationship between the equipment actions and the scenarios. Since the reference equipment-controlling means are developed the form of DLL (Dynamic Link Library) files, they do not need to be recompiled while being deployed. Meanwhile, the reference equipment-controlling means developed by the present invention are applicable to other equipments of the same type. Working together with various kinds of reference equipment-controlling means, the scenario editor 100 also can be used in different types of equipment.

Further, the scenario editor 100 can be connected to an event server used for notifying and handling the events occurring in the equipment 170, and can be connected to an alarm server used for notifying and handling the abnormal conditions of the equipment 170, and can be connected to a version-controlling server used for controlling the version of the editing-result file.

Hereinafter, the method of the present invention for dynamically controlling equipment actions is described.

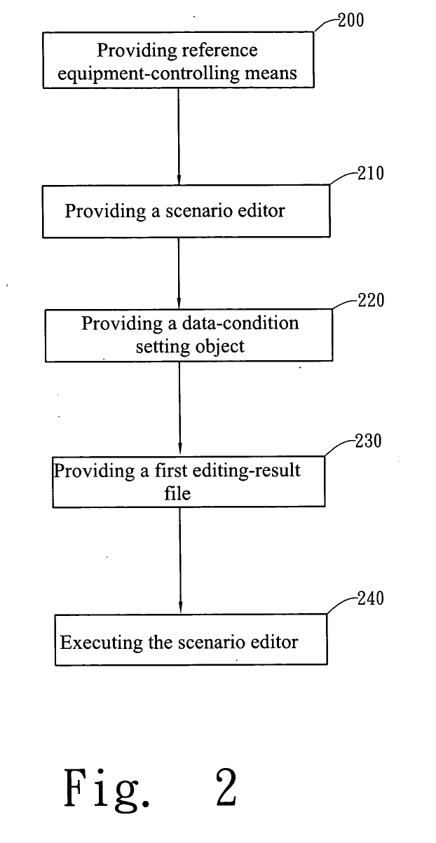

Referring to FIG. 2, FIG. 2 is a flow chart showing the method of the present invention for dynamically controlling equipment actions. At first, step 200 is performed to provide a plurality of reference equipment-controlling means used for controlling a plurality of reference actions of a plurality of reference equipments. Then, step 210 is performed to provide a scenario editor used for defining at least one equipment action of an equipment, wherein the scenario editor assigns a equipment-controlling means suitable for the equipment from the reference equipment-controlling means. Thereafter, step 220 is performed to provide a condition-data setting object used as a communication interface between the scenario editor and the equipment-controlling means. Then, step 230 is performed to provide a first editing-result file used for storing the result edited in the scenario editor. After the scenario editor loads in the first editing-result file, step 240 is performed to execute the scenario editor for changing the equipment action of the equipment.

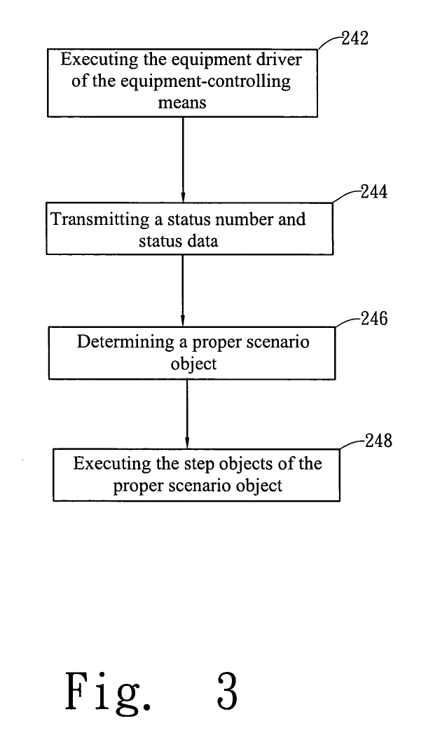

Referring to FIG. 3, FIG. 3 is a flow chart showing the steps of the present invention for executing a scenario editor. While the scenario editor is executed, step 242 is first performed to execute an equipment driver of the equipment-controlling means. Then, step 244 is performed to transmit a status number and status data. When the equipment driver of the equipment-controlling means triggers an equipment action, the status number and status data required by the equipment are transmitted to the scenario editor for execution via the condition-data setting object. On the other hand, while a scenario step is performed, if the action of the scenario step is to specifically execute the action of the equipment-controlling means, then the scenario editor executes an action object of the equipment-controlling means, and delivers the condition-data setting object to action object; and while the action object is executed, status information of the equipment is delivered to the scenario editor via the data-condition setting object, so that the scenario editor can base on the status information to determine if the next step is executed. Thereafter, step 246 is performed to determine a proper scenario object. After the scenario editor receives the status number and the status data, the scenario objects of the scenario editor are searched and compared so as to determine a proper scenario object suitable for the status number and the status data. Thereafter, step 248 is performed to execute step objects of the proper scenario object. An inspection step is performed to check if the step objects of the proper scenario object match with the status number and the status data, and the step objects are executed if the result is yes.

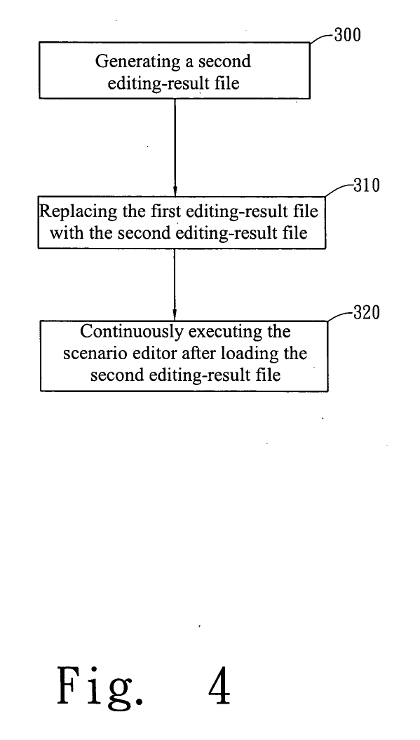

The present invention is further featured in that the equipment does not need to be stopped and the equipment actions of the equipment can be dynamically changed, so as to achieve the goal of plug-in and play. While changing equipment actions, the present invention merely needs to use another editing-result file to replace the original editing-result file, and then enables the scenario editor to load in the new editing-result file. Referring to FIG. 4, FIG. 4 is a flow chart showing the method of the present invention for dynamically changing equipment actions. At first, step 300 is performed to generate a second editing-result file, wherein the second editing-result file can be generated by another scenario editor. For example, the aforementioned scenario of loading the wafer pod into the equipment is changed to: (1) moving in a wafer pod; (2) docking in the wafer pod; and (3) clamping the wafer pod, and then the new scenario is saved in the second editing-result file.

Thereafter, step 310 is performed to replace the first editing-result file (Such as the aforementioned editing-result file 140) with the second editing-result file. Then, step 320 is performed to load the second editing-result file in the scenario editor, and then to continuously execute the scenario editor, so that the equipment actions can be dynamically changed without stopping the operation of the equipment, wherein the equipment-controlling means may notify the scenario editor to perform the step of loading in the second editing-result file.

Hence, it can be known from the aforementioned embodiments that the present invention has the following advantages. The present invention can dynamically change the equipment actions without stopping the equipment operations, thus having the function of plug-in and play; the related scenario-managing programs can be conveniently developed and maintained, so that developers merely need to focus on the development of equipment action objects and on the scenario editing; and the scenario results developed in the editor scenario is applicable to various types of equipment.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for dynamically controlling equipment actions, said method comprising:
providing a plurality of reference equipment-controlling means used for controlling a plurality of reference actions of a plurality of reference equipments, wherein each of said reference equipment-controlling means includes a reference equipment driver;
providing a scenario editor used for defining at least one equipment action of an equipment, wherein said scenario editor assigns an equipment-controlling means suitable for said equipment from said reference equipment-controlling means, said equipment-controlling means having an equipment driver;
providing a data-condition setting object used as a communication interface between said scenario editor and said equipment-controlling means, wherein said data-condition setting object controls acts as the input/output (I/O) of said equipment-controlling means;
providing a first editing-result file used for storing results edited in said scenario editor; and
executing said scenario editor to change said equipment action of said equipment after said scenario editor loads in said first editing-result file.

2. The method for dynamically controlling equipment actions according to claim 1, wherein said first editing-result file uses XML (Extensible Markup Language).

3. The method for dynamically controlling equipment actions according to claim 1, wherein said first editing-result file uses a user-defined format or is a storage media of database.

4. The method for dynamically controlling equipment actions according to claim 1, wherein said reference equipment-controlling means are DLL (Dynamic Link Library) files, and have a plurality of action objects.

5. The method for dynamically controlling equipment actions according to claim 1, wherein said scenario editor has a plurality of scenario objects, and each of said scenario objects has a plurality of step objects.

6. The method for dynamically controlling equipment actions according to claim 5, wherein said step for executing said scenario editor comprises:
executing said equipment driver of said equipment-controlling means;
transmitting a status number and status data, wherein said status number and said status data required by said equipment action are delivered to said scenario editor for execution, when said equipment driver triggers said equipment action;
determining a proper scenario object, wherein said proper scenario object is determined by searching and comparing said scenario objects, after said scenario editor receives said scenario number and said scenario data; and
executing said step objects of said proper scenario object, wherein if said step objects of said proper scenario object match with said scenario number and said scenario data, then said step objects are executed.

7. The method for dynamically controlling equipment actions according to claim 1, further comprising:
generating a second editing-result file for storing new results edited in said scenario editor;
replacing said first editing-result file by said second editing-result file; and
continuously executing said scenario editor after said scenario editor loads in said second editing-result file, so as to dynamically change said equipment action of said equipment.

8. The method for dynamically controlling equipment actions according to claim 7, wherein said equipment-controlling means notifies said scenario editor to load in said second editing-result file.

9. The method for dynamically controlling equipment actions according to claim 7, wherein said second editing-result file is generated by another scenario editor.

10. The method for dynamically controlling equipment actions according to claim 7, wherein said second editing-result file uses XML (Extensible Markup Language).

11. The method for dynamically controlling equipment actions according to claim 1, wherein each of said reference equipment-controlling means further comprises an equipment communication protocol.

12. The method for dynamically controlling equipment actions according to claim 1, wherein said step for executing said scenario editor comprises:
While a scenario step is executed, if the action of said scenario object is to specifically perform the action of said equipment-controlling means, then said scenario editor will execute an action object of said equipment-controlling means, and pass said data-condition setting object to said action object; and
While said action object is executed, status information of said equipment is delivered to said scenario editor via said data-condition setting object, so that said scenario editor can base on said status information to determine if the next step is executed.

13. A system for dynamically controlling equipment actions, said system comprising:
a plurality of reference equipment-controlling means used for controlling a plurality of reference actions of a plurality of reference equipments, wherein each of said reference equipment-controlling means includes an equipment driver;
a scenario editor used for defining or changing at least one equipment action of an equipment, wherein said scenario editor assigns an equipment-controlling means suitable for said equipment from said reference equipment-controlling means; and
a data-condition setting object used as a communication interface between said scenario editor and said equipment-controlling means, wherein said data-condition setting object acts as the input/output (I/O) of said equipment-controlling means;
a editing-result file used for storing results edited in said scenario editor, and said scenario editor is executed after loading in said editing-result file.

14. The system for dynamically controlling equipment actions according to claim 13, wherein said first editing-result file uses XML (Extensible Markup Language).

15. The system for dynamically controlling equipment actions according to claim 13, wherein said reference equipment-controlling means are DLL (Dynamic Link Library) files, and have a plurality of action objects.

16. The system for dynamically controlling equipment actions according to claim 13, wherein said scenario editor has a plurality of scenario objects, and each of said scenario objects has a plurality of step objects.

17. The system for dynamically controlling equipment actions according to claim 13, wherein said scenario editor is connected to an event server used for notifying events occurring on said equipment.

18. The system for dynamically controlling equipment actions according to claim 13, wherein said scenario editor is connected to an alarm server used for notifying abnormal behaviors of said equipment.

19. The system for dynamically controlling equipment actions according to claim 13, wherein said scenario editor is connected to a version-controlling server used for controlling the version of said editing-result file.

20. The system for dynamically controlling equipment actions according to claim 13, wherein each of said reference equipment-controlling means further comprises an equipment communication protocol.
